(19) United States
(12) Patent Application Publication
(10) Pub. No.: US 2024/0036899 A1
(43) Pub. Date: Feb. 1, 2024

(54) SYSTEM AND METHOD FOR CONTAINER-BASED CONTENT TRANSFER

(71) Applicant: Verizon Patent and Licensing Inc., Basking Ridge, NJ (US)

(72) Inventors: Jeemil Shah, Santa Clara, CA (US); Vijayan D. Nambiar, Shirley, MA (US); Musa Kazim Guven, Basking Ridge, NJ (US)

(21) Appl. No.: 17/815,808

(22) Filed: Jul. 28, 2022

(51) Int. Cl. G06F 9/455

(52) U.S. Cl. CPC G06F 9/45558; G06F 2009/4557; G06F 2009/45579

(57) ABSTRACT

A first device may include a pod and a processor. The processor may be configured to: receive a request, from a second device, to transfer a content item to the second device; and determine whether the content item can be transferred from the pod to the second device using a content caching container (CCC). When the processor determines that the content item cannot be transferred from the pod, the processor may be further configured to: send a reply, to the second device, indicating that the content item cannot be transferred from the pod to the second device; and enable caching the content item at the pod. When the processor determines that the content item can be transferred from the pod, the processor may be further configured to transfer the content item via a first CCC pm the pod to the second device.

### BACKGROUND INFORMATION

Virtual machines may include hardware, a hypervisor to emulate abstracted versions of the hardware, and an operating system. For virtual machines, hardware is virtualized. In contrast, a container is a program that is run by a container engine, which in turns runs on an operating system. For containers, the operating system is virtualized.

Virtual machines and containers offer different degrees of isolation for applications. For example, each application that runs on a virtual machine is isolated from another application at the emulated hardware level, although in reality the applications may be running on the same device. In contrast, each application that runs on a container engine is isolated from another container application at the emulated operating system level—each container application executes as if it were on a different operating system, although in reality, the applications are running on the same operating system.

### BRIEF DESCRIPTION OF THE DRAWINGS

FIG. 1 illustrates concepts described herein;

FIG. 2 illustrates an exemplary network in which systems and methods described herein may be implemented;

FIG. 3 depicts an exemplary container system according to an implementation;

FIG. 4 shows exemplary logical components of a content application, according to an implementation;

FIG. 5 shows exemplary logical components of a pod, according to an implementation;

FIG. 6 shows exemplary logical components of a coordinator, according to an implementation;

FIG. 7 is a flow diagram of an exemplary process that is associated with downloading a content caching container (CCC) to a pod, according to an implementation;

FIG. 8 is a flow diagram of an exemplary process that is associated with downloading content to a CCC, according to an implementation; and

FIG. 9 depicts exemplary functional components of a network device according to an implementation.

### DETAILED DESCRIPTION OF EMBODIMENTS

The following detailed description refers to the accompanying drawings. The same reference numbers in different drawings may identify the same or similar elements.

The systems and methods described herein relate to container-based transfer of content from a local device to an end device. Over the years, the behavior of content consumers has changed significantly (e.g., a change in time periods during which content consumers view most content). One consequence of the change is that a large number of consumers share similar patterns in accessing content. For example, consumers in a given geographical area may access contents mostly at certain times during a day, certain days in a week, etc. The change in behavior has caused the traffic to peak within particular time windows (herein referred to as peak time windows). During a peak time window, customers may experience latency and buffering, which result from the higher traffic demands.

To address the issues, both content providers and telecommunications service providers have built in additional capacity for handling data in their systems. Content providers, for example, have increased the number of servers to meet consumer demand. Similarly, telecommunications service providers have increased bandwidth for handling traffic at various stages in their networks. The additional capacity, however, are mostly used during peak time windows, which are relatively short time intervals. Accordingly, adding additional capacity tends to result in an inefficient use of resources.

Many content and telecommunications service providers have turned to Content Delivery Networks (CDNs) in order to reduce the impact of workloads and traffic on servers and networks. CDNs cache content at geographical locations close to customers and enable the customers to access the content with less latency. Because CDNs distribute communication and computational burdens over many devices, CDNs can mitigate the effects of large traffic resulting from increased demand for content. CDNs, nonetheless, may not resolve all issues that arise during peak time windows to the extent satisfactory to the consumers.

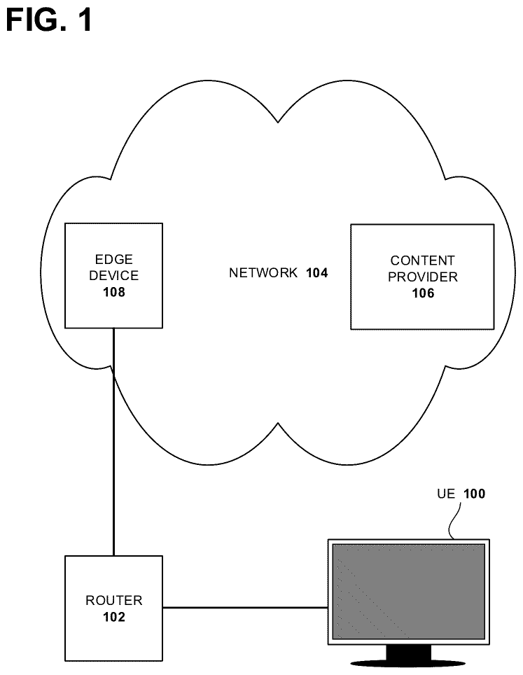

FIG. 1 illustrates the concepts described herein. As shown, a User Equipment device (UE) 102 and customer premises equipment (CPE) (e.g., devices located within the customer premises, such as a router 102) is attached to a network 104 to receive content (e.g., video, audio, etc.). As used herein, the term “customer premises” may be defined as an area or a location at which a customer of the content provider or the network service provider occupies. The customer may have a subscription with network 104 and/or with content provider 106. The term “content provider,” as used herein, may refer to an entity than owns and/or operates content provider 106. A “service provider” may refer to an entity that owns and/or operates network 104.

In FIG. 1, content may be sent from content provider 106 through a router 102 to UE 100. By caching the content at an edge device 108 and by providing the content from edge device 108, network 104 and content provider 106 may experience less traffic and workload. The reductions, however, may not be sufficient to free UE 100 from buffering or latency problems.

A system described herein may reduce traffic and workload at network 104, content provider 106, and/or edge device 108. Given typical consumer behavior, UE 100 at the customer premises may access the same content multiple times. In such a scenario, the system allows a device more local (e.g., geographically or logically) to UE 100 than edge device 108 (such as router 102) to cache the content. By having UE 100 obtain the content from the local device rather than edge device 108, the system may provide edge device 108 and network 104 a further relief from a high workload and traffic.

As described herein, the system may use containers to facilitate migration of cached content from edge devices 108 of network 104 toward the end devices (e.g., UE 100). The system automatically installs containers capable of caching and sharing content with other devices and/or other containers. These containers are herein referred to as content caching containers (CCC). CCCs may be installed by the system on a network device that includes a pod (to be described below) and operates as an access point (e.g., router 102 or edge device 108) to a local network (e.g., the local area network at the customer premises).

Because CCCs are easy to install and maintain, in some embodiments, the system may sometimes implement CCCs not only on pods local to UE 100, but also on pods on edge devices, such as edge device 108. After a CCC is installed on a pod, an agent on the pod may rank a task associated with a planned transfer of the content and place the task on a queue, with or without aid from a coordinator for exchanging contents by CCCs on network 104.

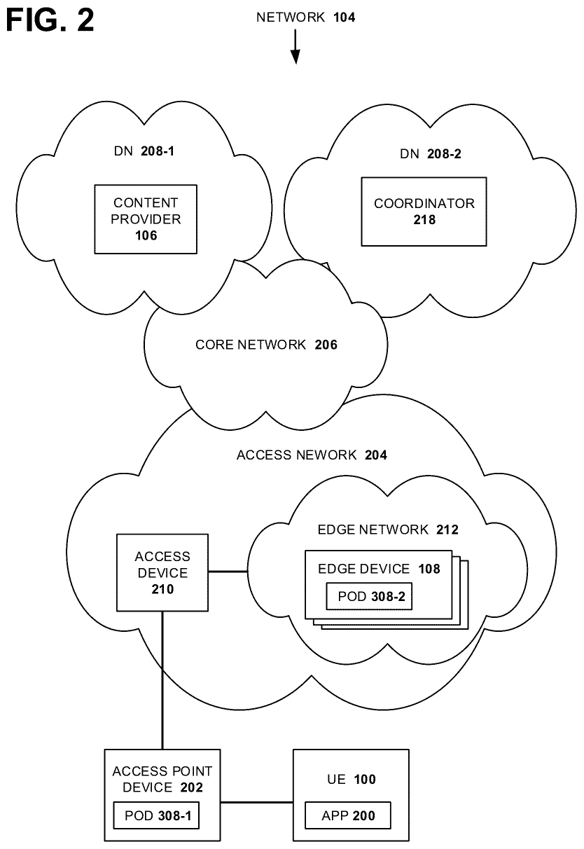

FIG. 2 illustrates an exemplary network environment in which the system described herein may be implemented. As shown, the environment may include UE 100 and an access point device 202, an access network 204, a core network 206, and data networks 208-1 and 208-2 (collectively referred to as data networks 208 or generically as data network 208). Components of the system for container-based content transfer may reside within UE 100, edge device 108, access point device 202, access network 204, core network 206, and/or data networks 208.

UE 100 may include a computational device linked wirelessly or through a wire or an optical cable to network 104 or to access point device 202. Examples of UE 100 include: a smart phone; a tablet device; a wearable computer device (e.g., a smart watch); a laptop computer; an autonomous vehicle with communication capabilities; a portable gaming system; a smart television; an audio play device; and an Internet-of-Thing (IoT) device. In some embodiments, UE 100 may correspond to a wireless Machine-Type-Communication (MTC) device that communicates with other devices over a machine-to-machine (M2M) interface, such as Long-Term-Evolution for Machines (LTE-M) or Category M1 (CAT-M1) devices and Narrow Band (NB)-IoT devices. UE 100 may send packets to or over access network 204.

As further shown, UE 100 may include a content application 200 (or simply application 200). Application 200 may include a user interface that allows a user to subscribe with content provider 106, select a content item to play at UE 100, purchase a content item, and/or play the selected content at UE 100 when it is received from an access point device 202, edge device 108, or content provider 106. When the user selects a particular content item, if application 200 determines that the content item requested by the user can be obtained from an access point device 202 close to UE 100, application 200 may query an agent (to be described below) on the access point device 202 whether a CCC on access point device 202 can provide the content item. If the response from the agent indicates that the content can be obtained from the CCC, application 200 may obtain the content from the CCC. Otherwise, application 200 may obtain the content from another CCC (e.g., installed on a device other than access point device 202) or from content provider 106.

Access point device 202 may include a gateway to a network local to UE 100 (not shown). Examples of access point device 202 includes a Fixed Wireless Access (FWA) device; a router; a modem; a customer-premises equipment (CPE) device; and a gateway device. Access point device 202 may be attached wirelessly to access network 204 (e.g., to a base station in access network 204) or by a wire or an optical cable to access network 204. Access point device 202 may operate as a device through which another device in network 104 may communicate with UE 100, or conversely, a device through which UE 100 may access services provided by network 104.

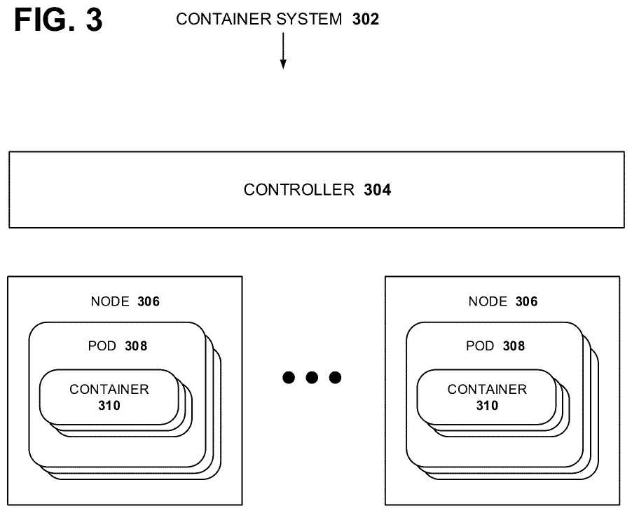

As further shown, access point device 202 may include a pod 308-1 and various hardware and software components for hosting a pod 308-1 on access point device 202. Pod 308-1 includes components that permit contents to be cached on access point device 202 and accessed by UE 100. The components may include, for example, an agent and a CCC. When an agent on access point device 202 receives messages from application 200, the agent may permit UE 100 to access the content from the CCC, if available. Pods 308-1 and pod 308-2 (collectively pods 308) and some of these components described below with reference to FIGS. 3 and 5.

Access network 204 may allow UE 100 to connect to core network 206, data network 208, and other devices associated with or included in network 104 (e.g., another UE 100). To do so, access network 204 may establish and maintain, with participation from UE 100 or access point device 202, an over-the-air, wired, or optical channel with UE 100 and maintain backhaul channels with core network 206. Access network 204 may convey information through these channels, from UE 100 to core network 206 and vice versa.

Access network 204 may include a Long-Term Evolution (LTE) radio network, a Fifth Generation (5G) radio network, another type of advanced radio network, a Local Area Network (LAN), a wide area network (WAN), or any type of access network through which UE 100 can access core network 206 or data network 208. The radio networks of access network 204 may operate in many different frequency ranges, including millimeter wave (mmWave) frequencies, sub 6 GHz frequencies, and/or other frequencies. Access network 204 may include many access stations, one of which is shown as access device 210.

Access device 210 may include a 4G, 5G, or another type of access device (e.g., a wireless station, a base station, an evolved Node B (eNB), a next generation Node B (gNB), a Central Unit (CU), a Distributed Unit (DU), a Radio Units (RU), a gateway, etc.). Some access devices 210 may include Radio Frequency (RF) transceivers for wireless or cellular communication. Other access devices may include gateway devices that serve as access points to network 104. In some implementations, access device 210 may include Integrated Access and Backhaul (IAB) nodes (not shown). Access device 210 may establish and maintain one or more channels with access point device 202 and backhaul channels with core network 206. The channels may be established a wired, over-the-air, or an optical link.

As also shown, access device 210 may be coupled to one or more of edge network 212 that comprises edge devices 108. Examples of edge network 212 includes a Multi-Access Edge Computing (MEC) network. When edge network 212 is embodied as a MEC network, edge devices 108 may include MEC devices. Edge network 212 may be located geographically close to access devices and, therefore, also be close to access point device 202/UE 100 serviced by the access device 210. Due to its proximity to access point device 202/UE 100, edge device 108 may be capable of providing services to UE 100 with minimal latency. Depending on the embodiment, edge network 212 may provide many core network functions and application functions at network edges. In other embodiments, an edge network 212 may be positioned at other locations (e.g., at core network 206) at which the edge network 212 can provide computational resources for improved network performance.

In some embodiments, edge device 108 may each include a pod 308-2. Similar to pod 308-1, pod 308-2 includes components that permit contents to be cached on edge device 108 and be accessed by UE 100, access point device 202, and/or other edge devices 108.

Core network 206 may include 4G core network components. 5G core network components, or another type of core network components. Examples of 4G core network components include a Serving Gateway (SGW), a Packet data network Gateway (PGW), and a Mobility Management Entity (MME). Examples of 5G core network components include a User Plane Function (UPF), an Application Function (AF), an Access and Mobility Function (AMF), a Session Management Function (SMF), a Unified Data Management (UDM) function, a Network Slice Selection Function (NSSF), and a Policy Control Function (PCF). Core network 206 may allow the delivery of Internet Protocol (IP) services UE 100 and may interface with other networks, such as data networks 208-1 and 208-2.

Data networks 208 may include networks that are external to core network 206. In some embodiments, data networks 208 may include packet data networks, such as an Internet Protocol (IP) network or another type of network. For example, data networks 208 may include a local area network (LAN), a wide area network (WAN), a metropolitan area network (MAN), an optical network, a cable television network, a satellite network, a wireless network (e.g., a Code Division Multiple Access (CDMA) network, a general packet radio service (GPRS) network, an LTE network (e.g., a 4G network), a 5G network, an ad hoc network, a telephone network (e.g., the Public Switched Telephone Network (PSTN), an intranet, or a combination of networks.

As shown, data network 208-1 includes content provider 106, and data network 208-2 includes a coordinator 218. When requested by UE 100 or pods 308 (on edge devices 108 or access point devices 202), content provider 106 may send contents to the UE 100 and/or the pods 308, through data network 208-1, through core network 206 and access network 204, and/or through access point device 202. Content provider 106 may include information (e.g., a portion of subscription information for a particular customer) that may aid a network component in determining whether a content item requested by UE 100 can be cached at and streamed from a CCC close to UE 100. When application 200 requests such information from content provider 106, content provider 106 may forward the information to application 200.

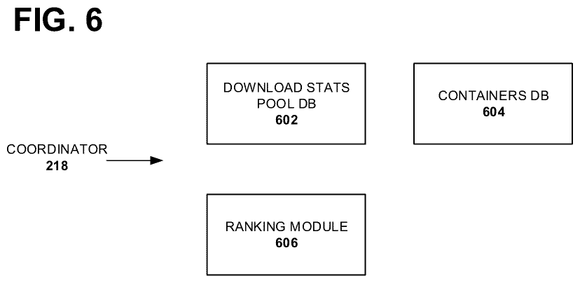

Coordinator 218 may coordinate transfer of content between CCCs on pods 308 or between content provider 106 and a CCC based on download statistics on contents accessed from the CCCs and/or UEs 100. Coordinator 218 is further described below in with references to FIG. 6. Depending on the implementation, coordinator 218 may also include parts of a container system for managing containers, such as CCCs.

For simplicity, FIG. 2 does not show all components that may be included in the network environment of FIG. 2 or in network 104 (e.g., routers, bridges, wireless access points, additional networks, MEC clusters, MEC networks, UEs 100, access point devices 202, edge devices 108, access devices 210, etc.). Depending on the implementation, network 104 may include additional, fewer, different, or a different arrangement of components than those illustrated in FIG. 2. For example, in one implementation, content provider 106 and coordinator 218 may be part of a single data network 208-1.

FIG. 3 depicts an exemplary container system 302 according to an implementation. Devices that are capable of hosting CCCs (e.g., access point devices 202 or edge devices 108) and coordinator 218 may be part of container system 302 and may each include one or more of the components depicted in FIG. 3. As shown, container system 302 may include a controller 304 and nodes 306-1 through 306-M, wherein M is a positive integer. Depending on the embodiment, container system 302 may include additional, fewer, or different, or a different arrangement of components than those depicted in FIG. 3.

Controller 304 may manage applications and/or devices within system 302. For example, controller 302 may generate a deployment plan and deploy applications in accordance with the plan on a platform based on the service topology. The platform may comprise physical devices or virtual components (e.g., access point devices 202, edge devices 108, and/or coordinator 218), virtual machines, operating systems, a network, a cloud, etc. Controller 304 may manage container-based applications. For example, if some components of coordinator 218 are implemented as containers, controller 304 may manage those components.

In some implementations, controller 304 may run on a network node that functions as the master for tasks or processes that implement the applications at other network nodes. In such an implementation, controller 304 may include: an Application Programming Interface (API) server for communicating with client programs or external network elements; a monitor that tracks services, applications, processes and/or other elements in the container-based platform; and a scheduler for scheduling applications and/or services on various network nodes. For example, controller 304 may include programs or components for installing CCCs on various nodes. Additionally, in one embodiment, controller 304 may generate, for each container installation, an installation record. An installation record may include information pertaining to the install, such as a version number of the container, the geographical location of the device on which the installation is performed, a time of the installation, etc.

Nodes 306 may each include a virtual machine, a bare metal node, a software component, an operating system, or another component that is capable of functioning as a network element. For a container-based platform, nodes 306 may form a virtual network, where at least one of the nodes 306 is a master node 306 that hosts controller 304 and where other nodes 306 are worker nodes 306 that host the applications. For example, worker nodes 306 may host CCCs. Worker nodes 306 may comprise access point devices 202 and edge devices 108, for example.

As further shown, node 306 may include one or more pods 308. Each pod 308 is the smallest unit of virtual network element that can have an IP address or be coupled with another element (herein also called a service, which can represent a set of pods 308 with the same function) that has an IP address. Although pods 308 of the virtual network may communicate with one another via the services, a network element that is external to the platform can access pods 308 through what is referred to as an ingress. An ingress, as used herein, may refer to an API object that manages external access to the services in a cluster, through hypertext transfer protocol (HTTP or HTTPS). An ingress may provide load balancing, a session termination, and virtual hosting.

For flexibility in maintenance and operation of components, each of which may require different levels of security, each pod 308 may be associated with a configuration map and a secret, which is a repository of encrypted information (e.g., a password to a database). Pod 308 may obtain configuration parameters from its configuration map and obtain credentials (or other information that needs to be secure) from the secret. For high availability, pods 308 may recognize storage elements (herein referred to as volumes), to which pods 308 may store data for persistence.

As further shown, each pod 308 may include one or more containers 310. Each container 310 may include a complete set of code and environment settings for execution by a container engine that runs on top of an operating system. An application and all its dependencies can be collected into a single file and made into a container 310. Examples of containers 310 include: an agent; a CCC; and components of coordinator 218. Both the agent and the CCC are described below in greater detail.

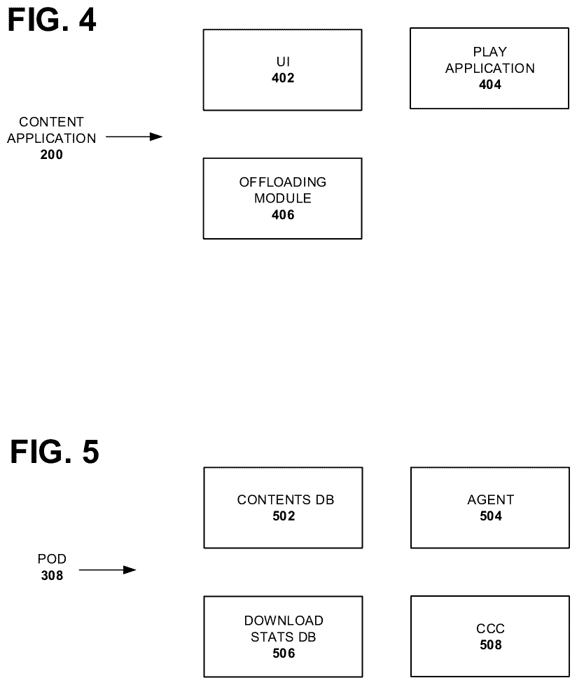

FIG. 4 shows exemplary logical components of content application 200 according to an implementation. As shown, application 200 may include a user interface (UI) 402, a play application 404, and an offloading module 406. UI 402 may allow a customer or user of application 200 to attach to a content provider 106, present a menu of contents that are available for consumption, allow the user to select a particular content, enable downloading or streaming of the selected content from content provider 106 or a CCC, and/or enable the user to perform various actions that are associated with contents.

Play application 404 may play or otherwise output content (e.g., present the content to user). Playing the content may entail, for example, playing a video clip, a movie, a television program, an audio clip, a song, etc. that is obtained or is being obtained from content provider 106 or a CCC. Play application 404 may call offloading module 408 to select the content provider 106, edge device 108, and/or access point device 202 to obtain the content therefrom.

Offloading module 406 may determine whether a content item can be obtained from a pod 308 or from a content provider 106. Offloading module 406 may maintain, in a local storage, information that identifies an address (e.g., an IP address or a Universal Resource Identifier (URI), etc.) associated with local pod 308 that is capable of caching content and/or an address of a content provider 106. Offloading module 406 may query an agent on pod 308 if a locally cached content is available for a download/stream, and if so, may direct the play application 404 to obtain the content from the local CCC on pod 308. Otherwise, offloading module 404 may instruct play application 404 to obtain the content from content provider 106 or a non-local pod 308 (e.g., pod 308-2 on edge device 108).

FIG. 5 shows exemplary logical components of pod 308 according to an implementation. As also indicated above with reference to FIG. 2, access point device 202 or edge device 108 may include pod 308. In FIG. 5, pod 308 is implemented to host containers for caching content—CCCs. As shown, pod 308 may include a contents database (DB) 502, an agent 504, a download stats DB 506, and a CCC 508. Contents DB 502 may include contents that are cached and/or shared via CCC 508. For each content that is stored at contents DB 502, contents DB 502 may also store a signature for the content. The signature may be generated by computing, for example, a hash of parameters and/or metadata associated with the content. Examples of the parameters and the metadata include a time of the content creation, the title of the content, and the quality of the content (e.g., high resolution audio or video, a dimension of the frames, etc.).

Agent 504 may receive a request for a content or a que from application 200 (e.g., play application 404 or offloading module 408) or from a CCC 508 on another pod 308. When agent 504 receives the request, agent 504 may determine whether an instance of CCC 508 for serving the content is installed and running on the pod 308. If a CCC 508 is not on the pod 308, agent 504 may notify the requesting application 200 or the requesting CCC 508 that no CCC 508 exists on the pod 308. Furthermore, home agent 504 may download a copy of the CCC 508, install the CCC 508, and run an instance of the CCC 508. Agent 504 may then request coordinator 218 to queue, on another pod 308, a transfer of the content to the CCC 508, which is on the same pod 308 as the agent 504. The requesting agent 504 is herein referred to as the home agent 504, and the CCC 508, which is on the same pod 308 as the home agent 504, is referred to as the home CCC 508.

In addition to determining whether a CCC 508 has been installed on pod 308, agent 504 may query contents DB 502, to determine whether the content is available from the contents DB 502. If the content is available, agent 504 may determine whether the content is up-to-date. To determine whether a content is up-to-date, agent 504 may forward a query, about the content to coordinator 218. The query may include the signature for the content. When coordinator 218 receives the query, coordinator 218 may compare the signature provided in the query to signatures for the most up-to-date content (e.g., signatures received from other CCCs 220 or content provider 106 as part of download stats). If the signatures match, the content is up-to-date, and coordinator 218 may forward a reply in the affirmative to agent 504.

If the reply from coordinator 218 indicates that the content is up-to-date, agent 504 may queue what is referred to as a transfer object. A transfer object (also herein referred to as “a transfer”) comprises an ID of the content and the ID of the CCC 508. A CCC 508 whose ID is on a transfer object that is the head of the queue may send the content whose ID is also on the same transfer object. When the transfer is complete, the transfer object is removed from the queue. A CCC 508 whose ID is on the transfer object that is the next head then processes the content whose ID is on the same transfer object.

During a transfer of the content by CCC 508, agent 504 may monitor various parameters associated with the transfer, such as a time of the transfer, bandwidth (e.g., load on the CCC 508, available bandwidth, used bandwidth, etc.), load on the CCC 508, an ID of the content provider 106 associated with the content, etc. Agent 504 may then store—the parameters along with the signature and metadata associated with the content (e.g., a priority associated with the content provider 106, the size of the content, a title of the content, a quality of the content, etc.) in download stats DB 506. When the transfer is complete, agent 504 may provide the record of the monitored parameters, along with the metadata and the IDs of the pod 308, agent 504, and/or CCC 508, to coordinator 218 for storage and use.

If the content is not up-to-date, agent 504 (the home agent 504) may perform one of the following (1) queue a transfer of the out-of-date content it to application 200; or (2) request coordinator 218 to have a different agent 504 (referred to as a foreign agent 504), which is on a pod 308 that has an updated content, queue an immediate transfer of the updated content to application 200. In addition, home agent 504 may request coordinator 218 to have the foreign agent 504 queue a transfer of the updated content to the home CCC 508.

For agent 504, the process of queuing a transfer includes ranking the transfer and based on the rank, inserting the transfer in an appropriate location within the queue. Agent 504 may rank a transfer based on one or more factors, such as: 1) total pending requests from the same content provider 106; 2) a time to expire; 3) past success criteria for the transfer; 4) total usage of the local copy of the content; 5) requests for the content from subscribers of other content providers 106; 6) the priority associated with the content provider 106; 7) the size of the content (or the payload); 8) content download size options 9) performance of the device on which the content is cached; and 10) the total number of application 200 instances accessing the content and/or the pod 308. In addition, the ranking may depend on whether the content is to be played as it is being streamed (which places a limit on the lowest rate at which the content should be transferred); whether the content is to be download rate has a lower limit; whether the content is to be sent to an application 200 or to a CCC 508.

When a home agent 504 requests coordinator 218 to have a foreign agent 504 to queue a transfer of a content to the home CCC 508, the home agent 504 may provide, to the coordinator 218, a local rank for the transfer of the content, as well as one of more of the factors used to determine the local rank. That is, home agent 504 may send the local rank and one or more of the above-listed factors to coordinator 218. The local rank may represent the order in which the home pod 308 may receive the content from a foreign CCC 508 and, accordingly, home agent 504 does not place the transfer on its queue.

Download stats DB 506 may store download statistics for contents. Such information may be provided to coordinator 218, which then uses the information for scheduling or coordinating transfer of contents between different CCCs 508. As indicated above, each record in download stats DB 506 may include a signature associated with a content item and a number of parameters monitored by the home agent 504 during a transfer of the content. Examples of the parameters include: a time of the transfer; the size of the content; bandwidth (e.g., available bandwidth, used bandwidth, etc.), load on the CCC 508 or pod 308, error rate, latency, etc. After the completion of a transfer and the record associated with the monitored parameters has been inserted into download stats DB 506, agent 504 may forward the record to coordinator 218, together with IDs for the agent 504, the CCC 508, and/or the pod 308.

CCC 508 may send a content item to ITE 100 or to another CCC 508. In addition, CCC 508 may receive a content item from another CCC 508 or content provider 106 and store the received content in contents DB 502. The protocol for transferring content to and from UE 100 and/or CCC 508 may be implementation dependent. For example, in one implementation, a home CCC 508 may initiate streaming based on messages from coordinator 218, UE 100, the home agent 504, and/or a foreign agent 504.

FIG. 6 shows exemplary logical components of coordinator 218 according to an implementation. As shown, coordinator 218 may include a download stats pool DB 602, a containers DB 604, and a ranking module 606. Download stats pool DB 602 may include records of each of the streams and downloads at different content providers 106 and pods 308. Each record may include a field for storing an ID associated with a content provider 106 or a pod 308 that sent the record to coordinator 218. In addition, the record may include fields similar to those in download stat DB 506 of pod 308.

Containers DB 604 may include a copy of one or more containers, such as a copy of CCC 508. In addition, containers DB 604 may include installation records (e.g., information regarding each installation of a container, such as the version number, the installation time and date, an ID of a pod 308 on which the container is installed, a geographical location of the install, etc.). If the node on which coordinator 218 is hosted is a master node of the container system 302, when controller 304 installs a CCC 508 on a pod 308, controller 304 may generate an installation record and insert it in containers DB 604. In a different embodiment, when coordinator 218 is not on a master node, the installation records in container DB 604 may have been obtained from the controller 304 on a master mode.

Ranking module 606 may receive a request from a home agent 502 to have a foreign agent 504 queue a download of a content item to the home CCC 508. The request may include a local rank associated with the content and/or information for one or more of the factors for ranking. Upon receipt of the request, ranking module 606 may use the containers DB 604 to identify a list of foreign agents 504 and/or CCCs 508 that may forward the content to the home CCC 508. The list may be obtained based on, for example, the geographical locations or topological locations of the foreign pods 308 and the location of the home agent 504. In addition, ranking module 606 may cull the list by selecting foreign agents 504 and/or CCCs 508 that are able to provide the content (e.g., ones with a download record of the contents with the matching signatures).

After obtaining the list of foreign agents 504/CCCs 508 that can provide the content, ranking module 606 may use the information provided in the request from the home agent (e.g., the local rank, ranking factors, etc.) and information pertaining to downloads of the content from the foreign CCCs 508 (stored in the download stats pool DB 602) to generate a global rank and to select one of the foreign agents 504/CCCs 508 identified in the culled list. Ranking module 606 may send the global rank and information used to rank the transfer to the selected foreign agent 504/CCC 508, along with the ID of the home agent 504/CCC 508—which is to receive the content from the foreign agent 504 or the foreign CCC 508. When the selected foreign agent 504 receives the information from the ranking module 505, the selected foreign agent 504 may locally rank the transfer and queue the transfer in accordance with the rank.

For simplicity, FIGS. 4-6 do not show all components that may be included in application 200, pod 308, and coordinator 218. Depending on the implementation, application 200, pod 308, and coordinator 218 may include additional, fewer, or different, or components than those illustrated in FIGS. 4-6. For example, in one implementation, coordinator 218 may include a separate database dedicated for storing records associated with installing CCCs 508 and/or a component dedicated for managing such a database.

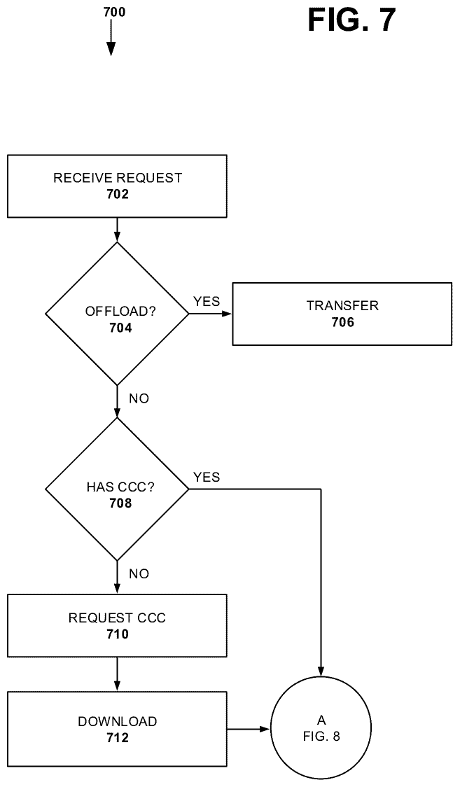

FIG. 7 is a flow diagram of an exemplary process 700 that is associated with downloading a copy of CCC 508 to a pod 308. Process 700 may be performed by, for example, application 200, controller 304, coordinator 218, and/or other components in network 104 and the network in a customer premises. For process 700, assume that if there is a different version of the same content in contents DB 502, agent 504 treats each version as a different content. As shown, process 700 may include application 200 receiving a request to obtain a content item (block 702). For example, application 200 may receive a selection of a particular content item and a request to have the content streamed and played at UE 100 from a user (a consumer of content) via a UI 402 of the application 200.

Upon receipt of the request, application 200 may determine whether the requested stream can be offloaded from the content provider 106 associated with the application 200 (block 704). Determining whether the content transfer can be offloaded from content provider 106 may include determining whether a local access point device 202 has cached the content and can stream the requested content to UE 100. For example, application 200 may obtain a signature for the content (from a local store on UE 100 or from content provider 106) and forward the request to the agent 504 on a pod 308 of access point device 202. In response, agent 504 may determine whether the content can be streamed from the home CCC 508. For example, agent 504 may look up a content item with the matching signature in its contents DB 502, and if so decide that the streaming can be offloaded from content provider 106 (block 704: YES). Accordingly, agent 504 may rank and queue the transfer. The home CCC 508 may transfer (e.g., stream) the content (block 706) when the transfer object becomes the head of the queue.

If agent 504 determines that the content cannot be transferred from the pod 308 (e.g., a content item with the matching signature is not in the contents DB 502) (block 704: NO), agent 504 may send a reply to the application 200 that the content is not available from the pod 308. The application 200 may then obtain the content from the content provider 106 or from another pod 308 (e.g., a pod 308 on edge device 108).

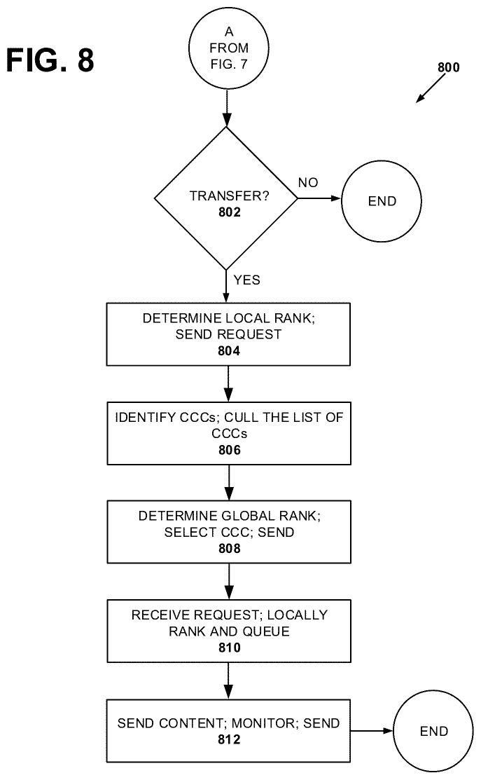

In addition, agent 504 may determine whether there is a CCC 508 for the requested content on the pod 308 (block 708). If agent 504 determines that there is a CCC 508 to handle a future transfer (bock 708: YES), process 700 may proceed to point A in process 800 of FIG. 8. Otherwise (block 708: NO), agent 704 may request a copy of CCC 508 (block 710), for example, from a controller 304 on the master node. A copy of the CCC 508 may be downloaded to the pod 308 (block 712) and installed. A CCC 508 may then be instantiated and run.

FIG. 8 is a flow diagram of an exemplary process 800 that is associated with downloading content to the home CCC 508, according to an implementation. Process 800 may be performed by, for example, application 200, CCC 508, coordinator 218, and/or other components in network 104 and the network in the customer premises. As shown, process 800 may include a home agent 504 or a home CCC 508 determining whether a content item is to be transferred to the home CCC 508 (block 802). For examine, agent 504 may determine that a content item is not up-to-date and decide that an up-to-date version of the content needs to be downloaded to contents DB 502. If there is no need to perform a transfer (block 802: NO), process 800 may end.

If agent 504 determines that a content item needs to be downloaded to the home CCC 508 (block 802: YES), agent 504 may determine a local rank of the potential receipt (block 804). Agent 504 may obtain the local rank based on one or more factors discussed above (block 804). Agent may then request coordinator 218 to have a foreign agent 504 queue a transfer of the content to the home CCC 508 (block 804). In the request, home agent 504 may provide the local rank, as well as one of more of the factors used to determine the local rank. The local rank may represent a possible order in which the home CCC 508 may receive the content from a foreign CCC 508 and, hence, home agent 504 does not place a transfer corresponding to the local rank on its transfer queue.

Upon receiving the request to have a foreign agent 504 queue a transfer of the content to the home CCC 504, coordinator 518 may identify a list of foreign agents 504 and/or CCCs 508 that may forward the content to the home CCC 508 (block 806). The list may be obtained based on, for example, the geographical locations or topological locations of the foreign pods 308 and the location of the home agent 504. For example, coordinator 218 may obtain the geographical locations of the pods 308 from containers DB 604 and select CCCs 508 on pods 308 which are located within a threshold distance from the home pod 308. In addition, coordinator 218 may cull the list by selecting foreign agents 504 and/or CCCs 508 that are able to provide the content (e.g., ones associated with a download record of the contents with the matching signatures) (block 806). Coordinator 218 may obtain such information from its download stats pool DB 602 (e.g., a record of a particular CCC 508 transferring the content).

After obtaining the list of foreign agents 504/CCCs 508 that can provide the content, coordinator 218 may use the information provided in the request from the home agent (e.g., the local rank, ranking factors, etc.) and information pertaining to downloads of the content from the foreign CCCs 508 (stored in the download stats pool DB 602) to generate a global rank and to select one of the foreign agents 504/CCCs 508 in the culled list (block 808). Coordinator 218 may then send the global rank and information used to globally rank the potential transfer to the selected foreign agent 504/CCC 508, along with the ID of the home agent 504/CCC 508—which is to receive the content from the foreign CCC 508 (block 808). In addition, coordinator 218 may notify the home agent 504 about the foreign CCC 508 that is to send the content.

When the selected foreign agent 504/CCC 508 receives the information from coordinator 218, the selected agent 504/CCC 508 may locally rank the transfer and queue the transfer in accordance with the rank (block 810). When the queued transfer becomes the head of the queue on the foreign pod 308, the foreign CCC 508 may send the content to the home CCC 508 (block 812). During the transfer, the foreign agent 504 may monitor various parameters that are associated with the transfer (block 812) and record the parameters in its download stat DB 502. After the transfer is complete, the foreign agent 504 may forward the record to coordinator 218. Coordinator 218 may insert the record, along with the ID of the pod 308, the agent 504, and/or the CCC 508 in the download stat pool DB 602.

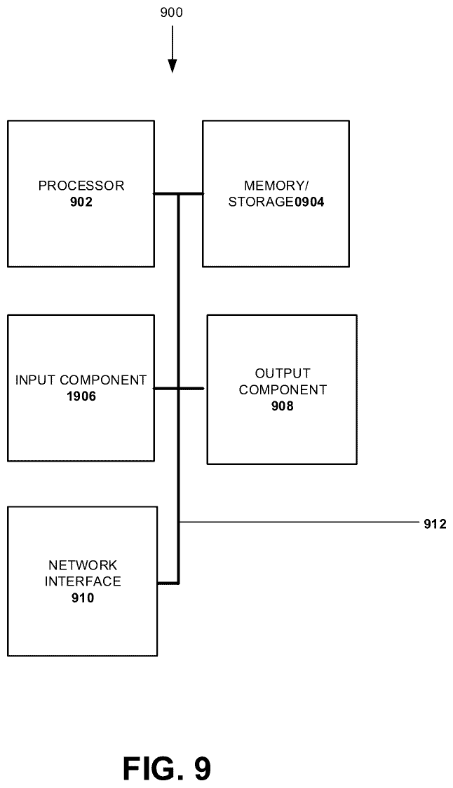

FIG. 9 depicts example components of a network device 900. UE 100, edge device 108, access point device 202, access network 204, core network 206, data networks 208, access device 210, devices hosting content provider 106 and coordinator 218, and/or other elements in network 104 (e.g., routers, bridges, gateways, servers, switches, etc.) may include or be implemented by or implemented on one or more of network device 900. As shown, network device 900 includes a processor 902, memory/storage 904, input component 906, output component 908, network interface 910, and communication path 912. In different implementations, network device 900 may include additional, fewer, different, or a different arrangement of components than the ones illustrated in FIG. 9. For example, network device 900 may include a display, network card, etc.

Processor 902 may include a processor, a microprocessor, an Application Specific Integrated Circuit (ASIC), a Field Programmable Gate Array (FPGA), a programmable logic device, a chipset, an application specific instruction-set processor (ASIP), a system-on-chip (SoC), a central processing unit (CPU) (e.g., one or multiple cores), a microcontrollers, and/or another processing logic device (e.g., embedded device) capable of controlling device 900 and/or executing programs/instructions.

Memory/storage 904 may include static memory, such as read only memory (ROM), and/or dynamic memory, such as random access memory (RAM), or onboard cache, for storing data and machine-readable instructions (e.g., programs, scripts, etc.). Memory/storage 904 may also include a CD ROM, CD read/write (R/W) disk, optical disk, magnetic disk, solid state disk, holographic versatile disk (HVD), digital versatile disk (DVD), and/or flash memory, as well as other types of storage device (e.g., Micro-Electromechanical system (MEMS)-based storage medium) for storing data and/or machine-readable instructions (e.g., a program, script, etc.). Memory/storage 904 may be external to and/or removable from network device 900. Memory/storage 904 may also include, for example, a Universal Serial Bus (USB) memory stick, a dongle, a hard disk, off-line storage, a Blu-Ray® disk (BD), etc.

Depending on the context, the term “memory,” “storage,” “storage device,” “storage unit,” “computer-readable medium,” “non-transitory computer-readable medium,” and/or “medium” may be used interchangeably. For example, a “computer-readable storage device” or “computer-readable medium” may refer to both a memory and/or storage device.

Input component 906 and output component 908 may provide input and output from/to a user to/from device 900. Input and output components 906 and 908 may include, for example, a display screen, a keyboard, a mouse, a speaker, actuators, sensors, gyroscope, accelerometer, a microphone, a camera, a DVD reader, Universal Serial Bus (USB) lines, and/or other types of components for obtaining, from physical events or phenomena, to and/or from signals that pertain to device 900.

Network interface 910 may include a transceiver (e.g., a transmitter and a receiver) for network device 900 to communicate with other devices and/or systems. For example, via network interface 910, network device 900 may communicate with wireless station 108. Network interface 910 may include an Ethernet interface to a LAN, and/or an interface/connection for connecting device 900 to other devices (e.g., a Bluetooth interface). For example, network interface 910 may include a wireless modem for modulation and demodulation.

Communication path 912 may enable components of network device 900 to communicate with one another.

Network device 900 may perform the operations described herein in response to processor 902 executing software instructions stored in a non-transitory computer-readable medium, such as memory/storage 904. The software instructions may be read into memory/storage 904 from another computer-readable medium or from another device via network interface 910. The software instructions stored in memory or storage (e.g., memory/storage 904, when executed by processor 902, may cause processor 902 to perform processes that are described herein. For example, instructions that are associated with implementing components depicted in FIGS. 1-6 may be executed by processor 902. When executed by processor 902, the instructions may cause processor 902 to perform functions and processes described above with reference to FIGS. 1-8.

In this specification, various preferred embodiments have been described with reference to the accompanying drawings. Modifications may be made thereto, and additional embodiments may be implemented, without departing from the broader scope of the invention as set forth in the claims that follow. The specification and drawings are accordingly to be regarded in an illustrative rather than restrictive sense.

For example, while a series of blocks have been described above with regard to the process illustrated in FIGS. 7 and 8, the order of the blocks may be modified in other implementations. In addition, non-dependent blocks may represent acts that can be performed in parallel.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

To the extent the aforementioned embodiments collect, store or employ personal information provided by individuals, it should be understood that such information shall be collected, stored, and used in accordance with all applicable laws concerning protection of personal information. The collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, block, or instruction used in the present application should be construed as critical or essential to the implementations described herein unless explicitly described as such. Also, as used herein, the articles “a,” “an,” and “the” are intended to include one or more items. Further, the phrase “based on” is intended to mean “based, at least in part, on” unless explicitly stated otherwise.

What is claimed is:

1. A first device comprising a pod and a processor configured to:
receive a request, from a second device, to transfer a content item to the second device;
determine whether the content item can be transferred from the pod to the second device using a content caching container (CCC); and
when the processor determines that the content item cannot be transferred from the pod,
send a reply, to the second device, indicating that the content item cannot be transferred from the pod to the second device; and
enable caching the content item at the pod; or
when the processor determines that the content item can be transferred from the pod,
transfer the content item via a first CCC on the pod to the second device.

2. The first device of claim 1, wherein the first device includes an edge device in a service provider network, and wherein the second device is in a network of a customer premises.

3. The first device of claim 1, wherein the first device and the second device are included in a network of a customer premises.

4. The first device of claim 1, wherein when determining whether the content item can be transferred, the processor is further configured to at least one of:
determine whether the content item is stored in a database on the first device; or
determine whether the pod includes the first CCC.

5. The first device of claim 1, wherein when enabling the caching, the processor is further configured to:
determine whether a CCC is installed on the pod; and
install a CCC on the pod if it is determined that a CCC is not installed on the pod.

6. The first device of claim 5, wherein when enabling the caching, the processor is further configured to:
request a coordinator to arrange for the content item to be sent to the installed CCC.

7. The first device of claim 6, wherein the coordinator is configured to:
select a second pod or a content provider to send the content item to the installed CCC;
determine a global rank for a transfer of the content item to the installed CCC; and
request the content provider or the second pod to send the content item to the installed CCC.

8. The first device of claim 1, wherein when transferring the content item, the processor is further configured to:
rank a transfer of the content item; and
queue a transfer object representing the transfer in accordance with the rank.

9. The first device of claim 8, wherein when ranking the transfer, the processor is further configured to determine one or more of:
a total number of requests for the content item;
a time to expire;
total usage of a local copy of the content item;
a number of requests for the content item from subscribers of other content providers;
a size of the content item;
content download size options;
performance of the first device; or
a total number of application instances accessing the content item.

10. The first device of claim 1, wherein when determining whether the content item can be transferred, the processor is further configured to:
determine a signature of the content item.

11. A method comprising:
receiving, at a first device, a request from a second device, to transfer a content item to the second device;
determining whether the content item can be transferred from a pod on the first device to the second device using a content caching container (CCC); and
when it is determined that the content item cannot be transferred from the pod,
sending a reply, from the first device to the second device, indicating that the content item cannot be transferred from the pod to the second device; and
enabling caching the content item at the pod; or
when it is determined that the content item can be transferred from the pod,
transferring the content item via a first CCC on the pod to the second device.

12. The method of claim 11, wherein the first device includes an edge device in a service provider network, and wherein the second device is in a network of a customer premises.

13. The method of claim 11, wherein the first device and the second device are included in a network of a customer premises.

14. The method of claim 11, wherein determining whether the content item can be transferred includes at least one of:
determining whether the content item is stored in a database on the first device; or
determining whether the pod includes the first CCC.

15. The method of claim 11, wherein enabling the caching includes:
determining whether a CCC is installed on the pod; and
installing a CCC on the pod if is it determined that a CCC is not installed on the pod.

16. The method claim 15, wherein enabling the caching includes:
requesting a coordinator to arrange for the content item to be sent to the installed CCC.

17. The method claim 16, wherein the coordinator is configured to:
select a second pod or a content provider to send the content item to the installed CCC;
determine a global rank of a transfer of the content item to the installed CCC; and
request the content provider or the second pod to send the content item to the installed CCC.

18. The method of claim 11, wherein transferring the content item includes:
ranking a transfer of the content item; and
queuing a transfer object representing the transfer in accordance with the rank.

19. A non-transitory computer-readable medium comprising process-executable instructions that, when executed by a processor on a first device cause the processor to:
receive a request, from a second device, to transfer a content item to the second device;
determine whether the content item can be transferred from a pod on the first device to the second device using a content caching container (CCC); and
when the processor determines that the content item cannot be transferred from the pod,
send a reply, to the second device, indicating that the content item cannot be transferred from the pod to the second device; and
enable caching the content item at the pod; or
when the processor determines that the content item can be transferred from the pod,
transfer the content item via a first CCC on the pod to the second device.

20. The non-transitory computer-readable medium of claim 19, wherein the first device includes an edge device in a service provider network, and wherein the second device is in a network of a customer premises.
